(19) United States
(12) Patent Application Publication
(10) Pub. No.: US 2019/0184569 A1
(43) Pub. Date: Jun. 20, 2019

(54) ROBOT BASED ON ARTIFICIAL INTELLIGENCE, AND CONTROL METHOD THEREOF

(71) Applicant: Bot3, Inc., Santa Clara, CA (US)

(72) Inventor: Chi-Min Huang, Santa Clara, CA (US)

(21) Appl. No.: 15/846,127

(22) Filed: Dec. 18, 2017

(51) Int. Cl. B25J 9/16; G05D 1/02; B25J 11/00

(52) U.S. Cl. CPC B25J 9/1697; B25J 9/163; B25J 11/0085; G05D 1/0246; G05D 1/0274; G05D 1/0238

(57) ABSTRACT

The present invention discloses a robot, including: a receive module configured to receive image signal and/or voice signal; an AI module configured to determine use's intention based on the image signal and/or voice signal; a sensor module configured to capture location information that indicates distances from a portion of the robot to an obstacle and a ground surface; a processor module configured to draw a room map of the room in which the robot is located based on the user's intention, and perform positioning, navigation, and path planning according to the room map; a control module configured to send a control signal to control movement of the robot in the room along the a path; and a motion module configured to control operation of a motor to drive the robot to perform the use's intention. In the present invention, the robot and control method thereof can provide home interaction service.

### TECHNICAL FIELD

The present invention relates to robot control field, and in particular relates to a robot based on artificial intelligence and control method thereof, which can provide home interaction service.

### BACKGROUND

With the increasing popularity of smart devices, the mobile robots become common in various aspects, such as logistics, home care, etc. AI (Artificial Intelligence) represents technology of imitate the human thinking and behavior by using computer science and modern tools. With the development of AI technology, it has been used in every aspect of our lives. However, such mobile robots with AI technology lack an ability to correct travel paths based on a configuration and layout of a space in which the robots are located. Thus, it is quite necessary to develop a robot with AI technology and improve interaction service effect, and provide user better service experience.

### SUMMARY

The present invention disclose a robot, comprising: a receive module, configured to receive image signal and/or voice signal where the robot is located; an AI module, coupled to the receive module, configured to determine use's intention based on the image signal and/or voice signal; a sensor module, configured to capture location information that indicates distances from a portion of the robot to an obstacle and a ground surface; a processor module, coupled to the receive module and the AI module, configured to draw a room map of the room in which the robot is located based on the user's intention, and perform positioning, navigation, and path planning according to the room map; a control module, coupled to the processor module, configured to send a control signal to control movement of the robot in the room along the a path according to the user's intention; and a motion module, configured to control operation of a motor to drive the robot to perform the use's intention according to the control signal.

The present invention also provide an control method for a robot, comprising: receiving an image signal and/or a voice signal by a receive module, inputted by a user; determining the user's intention based on the image signal and/or voice signal by a AI module; capturing location information that indicates distances from a portion of the robot to an obstacle and a ground surface by a sensor module; drawing a room map of the room in which the robot is located based on the user's intention, and performing positioning, navigation, and path planning according to the room map by processor module; sending a control signal to control movement of the robot in the room along the a path according to the user's intention by a control module; and performing the use's intention according to the control signal by controlling operation of a motor to drive the robot by a motion module.

Advantageously, in the present invention, the robot and control method thereof can provide home interaction service.

### BRIEF DESCRIPTION OF THE DRAWINGS

FIG. 1 illustrates a block diagram of a robot based on artificial intelligence technology according to one embodiment of the present invention.

FIG. 2 illustrates a block diagram of a processor module in the robot based on artificial intelligence technology according to one embodiment of the present invention.

FIG. 3 illustrates a block diagram of an AI module in the robot based on artificial intelligence technology according to one embodiment of the present invention.

FIG. 4 illustrates a flowchart of a control method for a robot based on artificial intelligence according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The present disclosure is directed to providing a robot based on artificial intelligence technology with a vision navigation function. Embodiments of the present robot can navigate through a room by using sensors in combination with a mapping ability to avoid obstacles that, if encountered, could interfere with the robot's progress through the room.

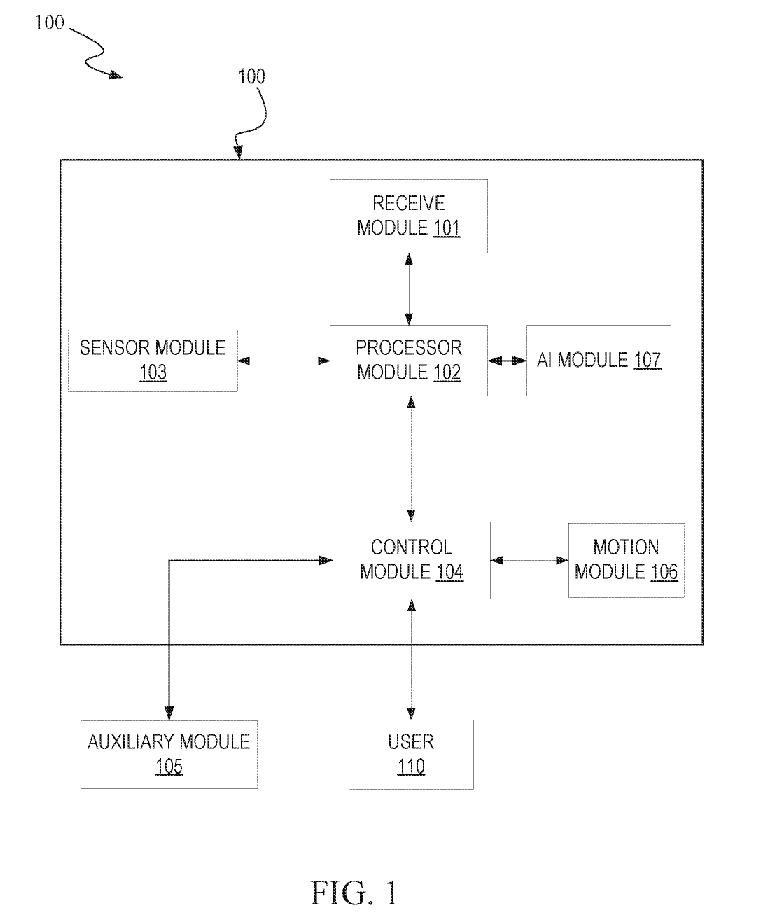

FIG. 1 illustrates a block diagram of a robot 100 based on artificial intelligence technology according to one embodiment of the present invention. As shown in FIG. 1, the robot 100 includes a receive module 101, a processor module 102, a sensor module 103, a control module 104, an auxiliary module 105 a motion module 106 and an AI (Artificial Intelligence, hereinafter as AI module) module 107. Each module described herein can be implemented as logic, which can include a computing device (e.g., structure: hardware, non-transitory computer-readable medium, firmware) for performing the actions described. As another example, the logic may be implemented, for example, as an ASIC programmed to perform the actions described herein. According to alternate embodiments, the logic may be implemented as stored computer-executable instructions that are presented to a computer processor, as data that are temporarily stored in memory and then executed by the computer processor.

In one embodiment, the receive module 101 (e.g., a image collecting unit and/or a voice collecting unit) in the robot 100 can be configured to capture surrounding images (e.g., ceiling image and/or ahead image of the robot 100), is also called image signal, which can be used for surrounding map construction. And the voice signal collected from user or surrounding can be configured to determine user's intentions. The image collecting unit in the receive module 103 can be configured to include at least one camera, for example, include an ahead camera and a top camera. The sensor module 103 can be configured to include at least one of the distance sensors and/or the cliff sensors, for example, and optionally other control circuitry to capture the location information related to the robot 100 (e.g., distances from the obstacle and ground). The sensor module 103 can optionally include a gyroscope, an infrared sensor, or any other suitable type of sensor for sensing the presence of an obstacle, a change in the robot's direction and/or orientation, and other properties relating to navigation of the robot 100.

According to the data captured by the receive module 101 and the sensor module 103, the processor module 102 can draw the room map of the robot, store the current location of the robot, store feature point coordinates and related description information, and perform positioning, navigation, and path planning. For example, the processor module 102 plans the path from a first location to a second location for the robot. The control module 104 (e.g., a micro controller MCU) coupled to the processor module 102 can be configured to send a control signal to control the motion of the robot 100. The motion module 106 can be a driving wheel with driving motor (e.g., the universal wheels and the driving wheel), which can be configured to move according to the control signal. The auxiliary module 105 is an external device to provide auxiliary functions according to user's requirement, such as the tray and the USB interface (not shown in FIG. 1). The AI module 107 coupled to the receive module 101 and processor module 102 can be configured to match the image signal received from the receive module 101 with training models based on tensorflow AI module and distinguish the type of the object. Also, the voice signal is matched with stored data command to obtain a command signal, and the command signal is sent to the processor module 102 for processing.

The user 110 can give command about the motion direction of the robot 500, and the expected function of the robot 100, includes voice command, and is not limited so.

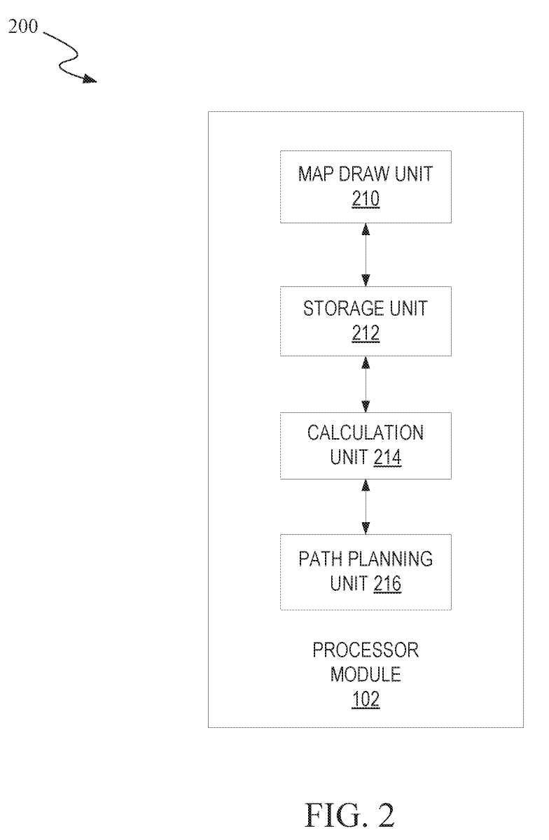

FIG. 2 illustrates a block diagram of the processor module 102 in the robot 100 according to one embodiment of the present invention. FIG. 2 can be understood in combination with the description of FIG. 1. As shown in FIG. 2, the processor module 102 includes a map draw unit 210, a storage unit 212, a calculation unit 214, and a path planning unit 216.

The map draw unit 210 can be configured as part of the image signal, processor module 102, or a combination thereof, to draw the room map of the robot 100 according to the image signal captured by the receive module 101 (as shown in FIG. 1), include information about feature points, and obstacles, etc. The image signal can optionally be assembled by the map draw unit 210 to draw the room map. According to alternate embodiments, edge detection can optionally be performed to extract obstacles, reference points, and other features from the image signal captured by the receive module 101 to draw the room map.

The storage unit 212 stores the current location of the robot in the room map drawn by the map draw unit 210, image coordinates of the feature points, and feature descriptions. For example, feature descriptions can include multidimensional description for the feature points by using ORB (oriented fast and rotated brief) feature point detection method.

The calculation unit 214 extracts the feature descriptions from the storage unit, matches the extracted feature descriptions with the feature description of the current location of the robot, and calculates the accurate location of the robot 100.

The path planning unit 216 takes the current location as the starting point of the robot 100, refers to the room map and the destination, and plans the motion path for the robot 100 relative to the starting point.

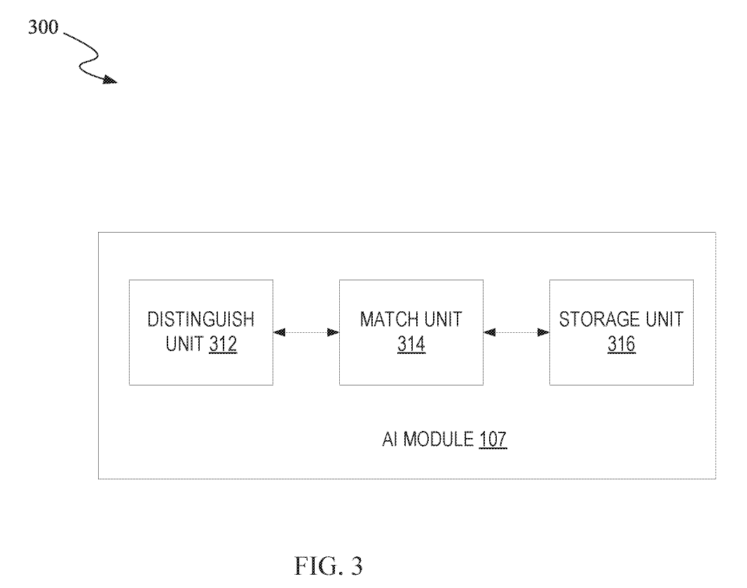

FIG. 3 illustrates a block diagram of a AI module in the robot based on artificial intelligence technology according to one embodiment of the present invention. FIG. 3 can be understood in combination with the description of FIG. 1. As shown in FIG. 3, the AI module 107 includes a distinguish unit 312, a match unit 314 and a storage unit 316.

The distinguish module 312 can be configured to distinguish image signal, for example, floor material, furniture, type of the room and objects stored in the room. Specifically, the distinguish module 312 can train models by using image signal and store the training models. The match unit 314 can be configured to match the image signal with the training models in the robot, and determine floor material, furniture, type of the room and objects stored in the room based on the image signal, but it is not limited to those determines.

In one embodiment, the image signal collected by the receive module 101 can be stored into the AI module in time as a training model. In a predetermined period, the AI module 107 can improve the distinguish ability of the image signal based on the stored image training models which is optimized by the image signal. In one embodiment, the image training models is stored into a local storage unit or in the cloud.

Moreover, the distinguish unit 312 is further configured to distinguish the voice signal captured by the receive module 101. In one embodiment, a voice collecting unit in the robot, for example, microphone can be configured to capture voice signal surrounding the robot, such as user's command or sudden voice information and so on. In another embodiment, the voice signal of the user is captured by a microphone. The match unit 314 can be configured to match voice signal in combination with natural language in the local or cloud with local voice training models, and extract the intentions in the voice signal. Also, the voice signal captured by the microphone can be stored into the AI module 107 as a part of the voice training models. In a predetermined period, the AI module 107 can improve the distinguish ability of the voice signal based on the stored voice training models which is optimized by the image signal. In one embodiment, the voice training models is stored into a local storage unit or in the cloud.

The storage unit 316 can be configured to store image training models, voice training models, image signal and voice signal above mentioned.

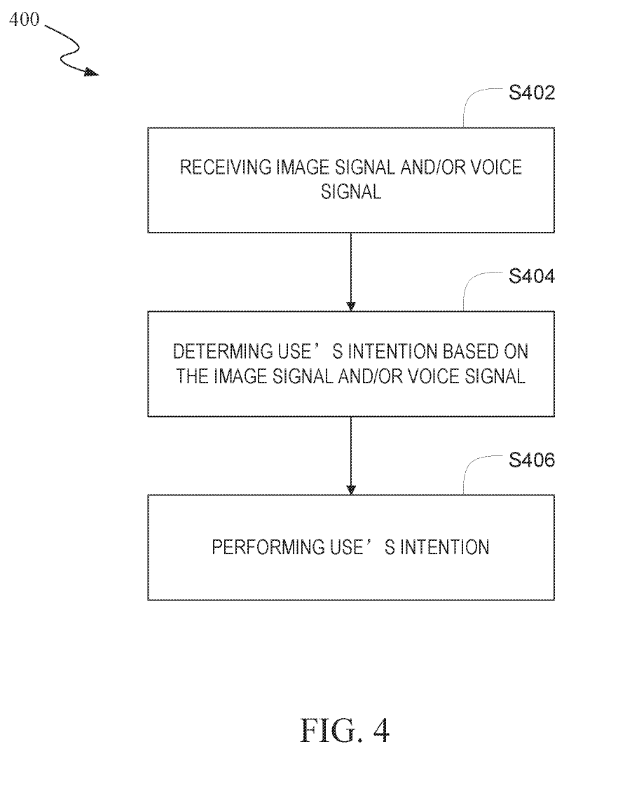

FIG. 4 illustrates a flowchart of a control method 400 for a robot based on the artificial intelligence according to one embodiment of the present invention. FIG. 4 can be understood in combination with the description of FIGS. 1-3. As shown in FIG. 3, the operation method 400 for the robot 100 can include:

Step 402: the robot 100 receives image signal and/or voice signal. Specifically. The receive module 101 in the robot 100 collects image signal and voice signal by camera and microphone respectively.

Step 404: the robot 100 determines user's intention based on the image signal and/or voice signal. Specifically, the AI module 107 in the robot 100 analyzes and processes the image signal and/or voice signal to determine user's intention. It should be explained that the AI module 107 can analyzes and processes one of the image signal and/or voice signal, or the combination of image signal and/or voice signal.

Step 406: the robot 100 performs the user's intention.

In one embodiment, the user instructs the robot 100 to clean the floor via the voice signal. While the receive module 101 in the robot 100 captures the image signal, the AI module 107 distinguish the floor material, furniture, type of the room and objects stored in the room based on the image signal, and work out a plan for cleaning the room. For example, the robot 100 can drive the motion module 106 with low speed, and increase cleaning suction when the floor material is carpet or analogues. The specific cleaning plan is performed by using the processor module 102 in combination the control module 104 to drive the motion module 106. The motion module can be drive with low speed motion, fast speed motion or round trip motion. For example, the robot decreases the driving speed, or increase cleaning suction when the floor was stained.

In another embodiment, the user instructs the robot 100 to a pointed area via the voice signal, for example, go to the kitchen or bedroom. While the AI module 107 extracts voice signal and process them, and send the processed voice signal to the processor module 107. The path planning unit 216 in the AI module 102 plan a path to the pointed area. More specifically, the control module 104 sends a control signal to drive the motion module 106 to the pointed area according to the planned path.

Advantageously, in the present invention, the robot based on the artificial intelligence and control method thereof can provide home interaction service.

Regarding to the robot 100 in this present invention, it can be a cleaning robot described in our previous application, i.e.: U.S. application Ser. No. 15/487,461, or a portable mobile robot in the previous application, i.e.: U.S. application Ser. No. 15/592,509.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A robot based on the AI (artificial intelligence), comprising:
a receive module, configured to receive image signal and/or voice signal where the robot is located;
an AI module, coupled to the receive module, configured to determine use's intention based on the image signal and/or voice signal;
a sensor module, configured to capture location information that indicates distances from a portion of the robot to an obstacle and a ground surface;
a processor module, coupled to the receive module and the AI module, configured to draw a room map of the room in which the robot is located based on the user's intention, and perform positioning, navigation, and path planning according to the room map;
a control module, coupled to the processor module, configured to send a control signal to control movement of the robot in the room along the a path according to the user's intention; and
a motion module, configured to control operation of a motor to drive the robot to perform the use's intention according to the control signal.

2. The robot according to claim 1, wherein the receive module is mounted on the top of the robot, and is configured to capture a ceiling image.

3. The robot according to claim 1, wherein the sensor module comprises an infrared distance sensor configured to sense a distance from obstacles to two sides of the robot, and an infrared cliff sensor configured to sense a change in elevation of the robot to interfere with the robot dropping down over the change in elevation.

4. The robot according to claim 1, wherein the processor module is configured to plan the path from a first location to a second location for the robot according to the image signal and the location information.

5. The robot according to claim 1, wherein the motion module performs low speed motion, fast speed motion and round trip motion.

6. The robot according to claim 1, wherein the AI module distinguishes floor material, type of the room and furniture before determining use's intention.

7. The robot according to claim 6, wherein the robot drives the motion module with low speed and increases cleaning suction when the floor material is carpet.

8. The robot according to claim 1, wherein the AI module distinguishes the voice signal and matches the voice signal with natural language before determining the user's intention.

9. A control method for a robot, comprising:
receiving an image signal and/or a voice signal by a receive module, inputted by a user;
determining the user's intention based on the image signal and/or voice signal by a AI module;
capturing location information that indicates distances from a portion of the robot to an obstacle and a ground surface by a sensor module;
drawing a room map of the room in which the robot is located based on the user's intention, and performing positioning, navigation, and path planning according to the room map by processor module;
sending a control signal to control movement of the robot in the room along the a path according to the user's intention by a control module; and
performing the use's intention according to the control signal by controlling operation of a motor to drive the robot by a motion module.

10. The control method for a robot according to claim 9, comprising:
distinguishing floor material, type of the room and furniture before determining use's intention.
